(19) United States
(12) Patent Application Publication
(10) Pub. No.: US 2013/0212231 A1
(43) Pub. Date: Aug. 15, 2013

(54) METHOD, APPARATUS AND SYSTEM FOR DYNAMIC MEDIA CONTENT INSERTION BASED ON HTTP STREAMING

(71) Applicant: Huawei Technologies Co., Ltd., (US)

(72) Inventors: Teng Shi, Shenzhen (CN); Yu Hui, Shenzhen (CN); Peiyu Yue, Shenzhen (CN)

(73) Assignee: Huawei Technologies Co., Ltd., Shenzhen (CN)

(21) Appl. No.: 13/838,072

(22) Filed: Mar. 15, 2013

Related U.S. Application Data
(63) Continuation of application No. PCT/CN2011/079505, filed on Sep. 9, 2011.

(30) Foreign Application Priority Data
Sep. 17, 2010 (CN) 201010291945.5

(51) Int. Cl. H04L 29/08

(52) U.S. Cl. CPC H04L 67/104
USPC 709/219

(57) ABSTRACT

Embodiments of the present invention disclose a method, an apparatus, and a system for dynamic media content insertion based on HTTP streaming, relating to the field of video technologies, and capable of implementing dynamic insertion of a customized media content. The dynamic media content is transmitted through HTTP streaming. The method includes: receiving, by a server, a request message that is sent by a client terminal and carries user information; screening out a target media content from locally stored media contents according to the user information; and sending the target media content to the client terminal so that the client terminal can play the target media content. Embodiments of the present invention are mainly applied to the process of dynamic media content insertion. When the client terminal watches a program through HTTP streaming, the customized insertion of the media content can be implemented.

### CROSS-REFERENCE TO RELATED APPLICATIONS

This application is a continuation of International Application No. PCT/CN2011/079505, filed on Sep. 9, 2011, which claims priority to Chinese Patent Application No. 201010291945.5, filed on Sep. 17, 2010, both of which are incorporated herein by reference in their entirety.

### FIELD OF THE INVENTION

The present invention relates to the field of video technologies and, in particular, to a method, an apparatus and a system for dynamic media content insertion based on HTTP streaming.

### BACKGROUND OF THE INVENTION

At present, different media contents can be inserted into a program stream by dynamic media content insertion. For example, customized advertisement insertion may implement the following function: when a user clicks a video, inserting a customized video advertisement according to the user's customized information before the video is played or when the video playing is ended, or by stopping playing of a program in the video playing process, inserting the customized advertisement content, and then returning to the original program after the advertisement is ended.

The prior art provides an Hypertext Transfer Protocol (HTTP)) streaming technology to implement advertisement insertion. By using the HTTP streaming technology, a multimedia content may be divided into several media segments and then the media segments are transmitted to a client terminal through the HTTP protocol. Uniform Resource Locators (URLs) of all media segments, wherein the segments is obtained by dividing the multimedia content, are described through an media presentation description (MPD) file. The structure of the MPD file is shown in FIG. 1. According to the sequence of a time axis, one MPD file is divided into one or multiple periods “Periods”, where each Period further includes description information “Representation” of different bit rates, and segment information “SegmentInfo” of each Representation describes URLs of several media segments. When the client terminal plays the multimedia content by using the HTTP streaming technology, the client terminal needs to request the MPD file first, and then request, according to the URL of each media segment in the MPD file, the content of the media segment which is going to play.

When the HTTP streaming technology in the prior art is used to implement dynamic media content insertion, taking dynamic advertisement insertion as an example, the insertion may be implemented in the following two modes:

Mode 1: By an encoder, a program content is directly divided into program segments, an advertisement content is directly divided into advertisement segments, and the program segments and advertisement segments are used to generate a segment sequence. After a client terminal receives an MPD file delivered by a server, the client terminal requests obtaining each segment in the segment sequence one by one according to the segment sequence which is described in the MPD file. When the segment requested by the client terminal is a program segment, the client terminal plays the content of the program segment, and the program is played at this time; when the segment requested by the client terminal is an advertisement segment, the client terminal plays the content of the advertisement segment, and the advertisement is played at this time, so that insertion of the advertisement is implemented.

Mode 2: Before the server delivers an MPD file to the client terminal, the server inserts an advertisement segment into the program segment sequence described in the MPD file. Then the server delivers the MPD file to the client terminal. The client terminal requests each segment one by one according to the segment sequence inserted with the advertisement segment described in the MPD file, and plays each segment.

### SUMMARY OF THE INVENTION

Embodiments of the present invention provide a method, an apparatus and a system for dynamic media content insertion based on HTTP streaming, which can solve the problem that customized insertion cannot be implemented when media contents are transmitted through HTTP streaming.

In order to achieve the foregoing objective, embodiments of the present invention adopt the following technical solutions.

A method for dynamic media content insertion based on HTTP streaming, where dynamic media contents are transmitted through HTTP streaming, includes:

receiving a request message that is sent by a client terminal and carries user information;

screening out a target media content from locally stored media contents according to the user information; and

sending the target media content to the client terminal so that the client terminal can play the target media content.

A method for dynamic media content insertion based on HTTP streaming, where dynamic media contents are transmitted through HTTP streaming, includes:

sending a request message that carries user information to a server; and

receiving a media content that is sent by the server and matches the user information, and playing the media content.

An apparatus for dynamic media content insertion based on HTTP streaming, where dynamic media contents are transmitted through HTTP streaming, includes:

a first receiving unit, configured to receive a request message that is sent by a client terminal and carries user information;

a screening unit, configured to screen out a target media content from locally stored media contents according to the user information; and

a first sending unit, configured to send the target media content to the client terminal so that the client terminal can play the target media content.

Another apparatus for dynamic media content insertion based on HTTP streaming, where dynamic media contents are transmitted through HTTP streaming, includes:

a first sending unit, configured to send a request message that carries user information to a server; and

a first receiving unit, configured to receive a media content that is sent by the server and matches the user information, and play the media content.

A system for dynamic media content insertion based on HTTP streaming includes:

the above apparatus for dynamic media content insertion based on HTTP streaming, configured to: receive a request message that is sent by a client terminal and carries user information; screen out a target media content from locally stored media contents according to the user information; and send the target media content to the client terminal so that the client terminal can play the target media content; and

another apparatus for dynamic media content insertion based on HTTP streaming, configured to: send a request message that carries user information to a server; and receive a media content that is sent by the server and matches the user information, and play the media content.

According to embodiments of the present invention described in the above technical solutions, when a client terminal watches a program through HTTP streaming, the media content received by the client terminal is obtained by screening by the server according to the user information. Because the user information of different client terminals has differences in customization, different users can receive customized media contents meeting respective requirements. Compared with the prior art in which all client terminals demanding a same program watch the same media content when the client terminals watch the program through HTTP streaming, embodiments of the present invention can enable all the client terminals demanding the same program to watch customized dynamic media contents meeting respective characteristics, thus solving the problem that customized insertion fails to be implemented when media contents are transmitted through HTTP streaming in the prior art, so that customized insertion of dynamic media contents is implemented.

### BRIEF DESCRIPTION OF THE DRAWINGS

To illustrate the technical solutions in embodiments of the present invention or the prior art more clearly, the accompanying drawings used in the description of the embodiments or the prior art are briefly described hereunder. Apparently, the accompanying drawings illustrate only some embodiments of the present invention, and persons skilled in the art can derive other drawings from these drawings without any creative effort.

FIG. 1 is a schematic structural diagram of an MPD file in the prior art;

FIG. 2 is a flowchart of a method for dynamic media content insertion based on HTTP streaming according to an embodiment of the present invention;

FIG. 3 is a flowchart of another method for dynamic media content insertion based on HTTP streaming according to an embodiment of the present invention;

FIG. 4 is a flowchart of a method for dynamic media content insertion based on HTTP streaming implemented by using mode 1 according to an embodiment of the present invention;

FIG. 5 is a flowchart of another method for dynamic media content insertion based on HTTP streaming implemented by using mode 1 according to an embodiment of the present invention;

FIG. 6 is a flowchart of still another method for dynamic media content insertion based on HTTP streaming implemented by using mode 1 according to an embodiment of the present invention;

FIG. 7 is a flowchart of a method for dynamic media content insertion based on HTTP streaming implemented by using mode 2 according to an embodiment of the present invention;

FIG. 8 is a structural diagram of an apparatus for dynamic media content insertion based on HTTP streaming according to an embodiment of the present invention;

FIG. 9 is a structural diagram of a server implemented by using mode 1 according to an embodiment of the present invention;

FIG. 10 is a structural diagram of a server implemented by using mode 2 according to an embodiment of the present invention;

FIG. 11 is a structural diagram of another apparatus for dynamic media content insertion based on HTTP streaming according to an embodiment of the present invention;

FIG. 12 is a structural diagram of a client terminal implemented by using mode 1 according to an embodiment of the present invention; and

FIG. 13 is a structural diagram of a client terminal implemented by using mode 2 according to an embodiment of the present invention.

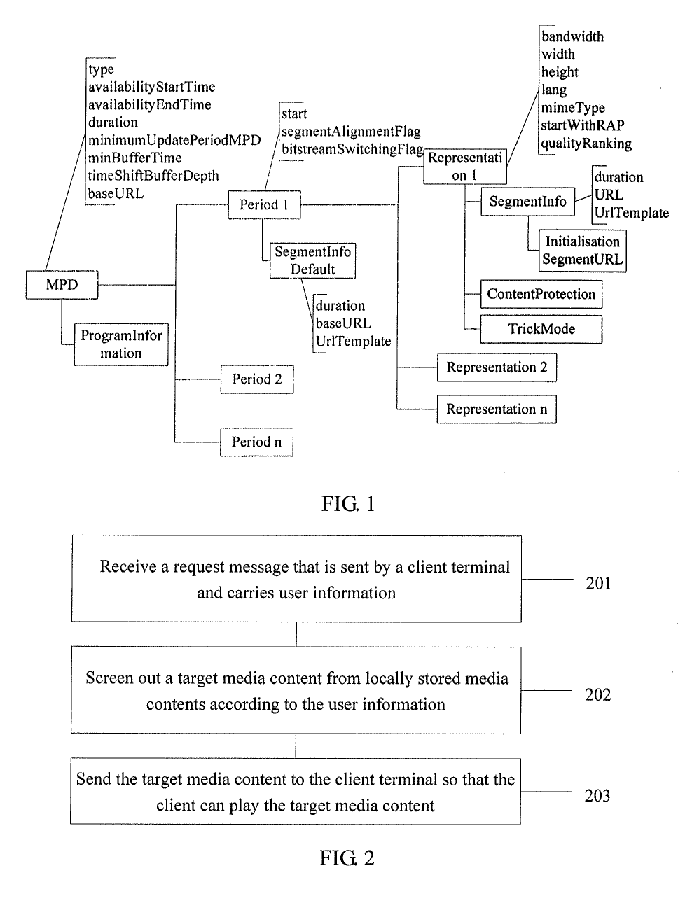

### DETAILED DESCRIPTION OF THE EMBODIMENTS

The technical solutions in embodiments of the present invention are hereinafter described clearly and completely with reference to the accompanying drawings. Evidently, the described embodiments are only a part of embodiments of the present invention, rather than all embodiments of the present invention. All the other embodiments obtained by persons skilled in the art without creative efforts based on embodiments of the present invention shall fall within the protection scope of the present invention.

An embodiment shown in FIG. 2 provides a method for dynamic media content insertion based on HTTP streaming, where the media contents are transmitted between a server and a client terminal through HTTP streaming. The method is hereinafter described from the perspective of the server. The method includes:

201. Receive a request message that is sent by a client terminal and carries user information.

The user information may be a user identifier, for example, a user ID; or the user information may be complete user description information, for example: name, sex, hobby and location of the user. In the actual application, the user information, which in the request message, may be described in xml format, but the form of the user information is not limited to the xml format.

202. Screen out a target media content from locally stored media contents according to the user information.

Because a conventional server has the function of screening media contents, when the server receives the user information, the server can use the user information as a screening condition, and screen out a target media content from locally stored media contents. The target media content, which is screened out, matches the user information.

203. Send the target media content to the client terminal so that the client terminal can play the target media content.

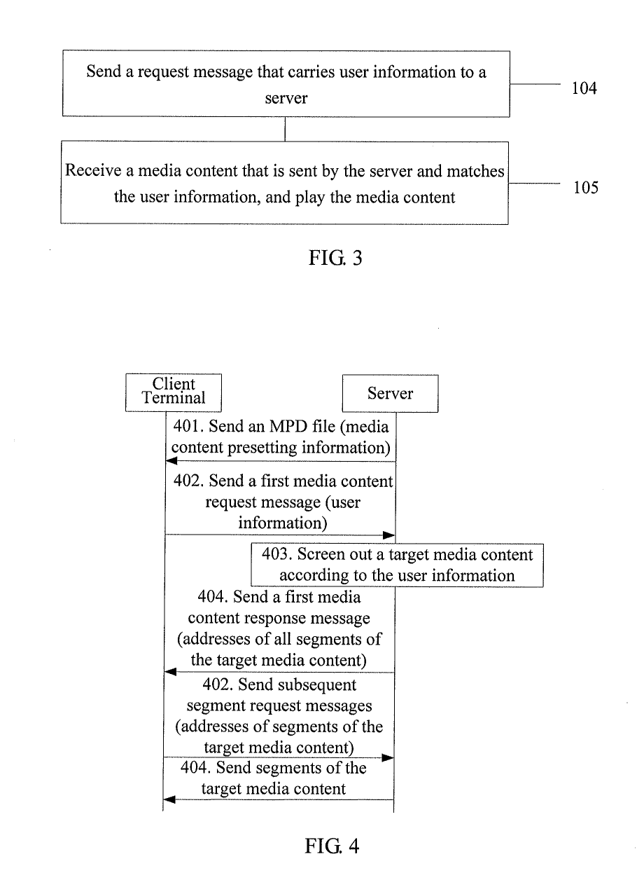

An embodiment shown in FIG. 3 provides a method for dynamic media content insertion based on HTTP streaming, where the media contents are transmitted between a server and a client terminal through HTTP streaming. The method is described from the perspective of the client terminal. The method includes:

301. Send a request message that carries user information to a server.

302. Receive a media content which is sent by the server and matched the user information, and play the received media content.

The method for dynamic media content insertion based on HTTP streaming according to embodiments of the present invention, because the media content receives by the client terminal is screening by the server according to the user information, while the user information of different client terminals has differences in customization, different users can receive dynamic media contents meeting respective requirements. Compared with the prior art in which all client terminals demanding a same program watch a same dynamic media content when the client terminals watch the program through HTTP streaming, embodiments of the present invention can enable all the client terminals demanding the same program to watch customized dynamic media contents meeting respective characteristics, thus solving the problem that customized insertion cannot be implemented when media contents are transmitted through HTTP streaming in the prior art, so that customized insertion of dynamic media contents is implemented.

During the specific implementation, the dynamic media content provided by embodiments of the present invention includes: an advertisement, a trailer of a program, one of subplots of a program, or any combination thereof.

The method for dynamic media content insertion based on HTTP streaming according to embodiments of the present invention can be implemented in the following two modes:

Mode 1: The server inserts media content presetting information into an MPD file. The client terminal obtains the MPD file through a request, when the client terminal reads the media content presetting information, the client terminal sends a media content request message to the server according to the media content obtaining information and insertion positions of media content segments, where the request carries user information, and the server screens out a target media content according to the user information. Afterwards, the server returns addresses of segments and/or content segments of the target media content to the client terminal, and the client terminal requests content segments according to the received addresses of the segments of the target media content or plays the received content segments.

Mode 2: The client terminal sends an MPD request message to the server, where the MPD request message carries user information. The server screens media contents according to the received user information, and inserts the addresses of the segments corresponding to the target media content, that is screened out, into the MPD file; afterwards, the server sends the MPD file to the client terminal. The client terminal requests segment contents one by one according to the addresses sequence of the segments in the MPD file. If an address of a program segment is requested, the client terminal receives and plays a program content sent by the server; if an address of a segment of the target media content is requested, the client terminal receives and plays the segment of the target media content.

The two implementation modes are hereinafter completely described in detail respectively.

An embodiment shown in FIG. 4 provides a method for dynamic media content insertion based on HTTP streaming, wherein the method implements customized media content insertion by using mode 1. The embodiment includes the following steps:

401. After receiving an MPD request message sent by the client terminal, send an MPD file that carries inserted media content presetting information to the client terminal.

The media content presetting information may be located in “Period”, or located in “Representation” under the “Period”, or located in “SegmentInfo” under the “Representation” which is under the “Period”; the media content presetting information includes: media content obtaining information and insertion position of the first media content segment.

It should be noted that the media content obtaining information includes an identifier of the insertion position of the media content. The identifier of the insertion position of the media content is used to obtain information associated with the insertion position of the media content. The insertion position of the first media content segment may be insertion time or an insertion index relative to the program segment.

In the actual application, as shown in the following Table 1, media content presetting information is added under “SegmentInfo”, where “SegmentInfo” is in the “Representation”, and “Representation” is under the “Period” (see AdInfo in Table 1). The media content presetting information may also be located in the “Period”, or located in the “Representation” which is under the “Period”. The media content presetting information includes three attributes: media content obtaining information (see “Ad-sourceURL” in Table 1), insertion index of the first media content segment (see “Ad-InsertIndex” in Table 1), and insertion time of the first media content segment (see “Ad-starttime” in Table 1).

The insertion index of the first media content segment (see “Ad-InsertIndex” in Table 1) is used to: when addresses of program segments are indicated by “UrlTemplate”, insert media contents before program segments whose index values are equal to “Ad-InsertIndex”, so that the value of the “Ad-InsertIndex” is between the start value (see “startindex” in Table 1) and the end value (see “endindex” in Table 1) of the program segments.

The insertion time of the first media content segment (see “Ad-starttime” in Table 1) is used to: when addresses of program segments are indicated by “UrlTemplate” or “Url”, insert media contents when the program is played to the time indicated by the “Ad-starttime”. If addresses of program segments are indicated by “Url”, the “AdInfo” is located between “Urls”, and the “Ad-starttime” is not defined, the insertion time of the first segment of the media content is indicated according to the sequence of the “AdInfo” in the “Url”.

TABLE 1

| | Type | | | |
|---|---|---|---|---|
| | (Attribute or | | | |
| Element or Attribute Name | Element) | Cardinality | Optionality | Description |
| MPD | E | 1 | M | MPD |
| . . . | | | | |
| Period | E | 1 . . . N | M | Information |
| | | | | description of each |
| | | | | Period |
| . . . | | | | |
| Representation | E | | M | Representation |
| | | | | description |
| . . . | | | | |
| SegmentInfo | E | 0, 1 | CM | Providing |
| | | | Must be | information of each |
| | | | present in case | segment |
| | | | SegmentInfo | |
| | | | is not present | |
| | | | on higher | |
| | | | levels | |
| UrlTemplate | E | 0, 1 | CM | Indicating a url |
| | | | Must be | template of program |
| | | | present if the | segments |
| | | | Url element is | |
| | | | not present. | |
| . . . | | | | |
| startIndex | A | | OD | Index of the first |
| | | | default: 1 | program segment in |
| | | | | the Representation |
| endIndex | A | | OD | Index of the last |
| | | | default: | program segment in |
| | | | infinite | the Representation |
| Url | E | 0, N | CM | Indicating addresses |
| | | | Must be | of program |
| | | | present if the | segments |
| | | | UrlTemplate | |
| | | | element is not | |
| | | | present. | |
| . . . | | | | |
| AdInfo | E | 0, 1 | 0 | Defining media |
| | | | | content presetting |
| | | | | information |
| Ad-sourceURL | A | | 0 | Defining media |
| | | | | content obtaining |
| | | | | information, where |
| | | | | the media content |
| | | | | obtaining |
| | | | | information |
| | | | | includes an |
| | | | | identifier of the |
| | | | | insertion position of |
| | | | | the media content |
| Ad-InsertIndex | A | | 1 by default | Insertion index of |
| | | | | the first media |
| | | | | content segment |
| | | | | relative to a |
| | | | | program segment |
| Ad-starttime | A | | 0 by default | Insertion time of the |
| | | | | first media content |
| | | | | segment, unit: s |
| . . . | | | | |

402. According to the media content, the client terminal sends a first media content request message carrying user information to obtain information in the MPD file.

For example, the description about the “Period” carrying media content presetting information in the MPD file received by the client terminal is expressed as follows:

```
  <Period start=“PT0S”>
    <Representation
      mimeType=“video/3gpp; codecs=s263, samr”
      bandwidth=“256000”>
      <SegmentInfo>
<AdInfo ad-sourceURL=http://www.example.com/Adselect/33
Ad-starttime=20 />
<url sourceurl=“www.example.com/program1.3gp”>
<url sourceurl=“www.example.com/program2.3gp”>
<url sourceurl=“www.example.com/program3.3gp”>
      </SegmentInfo>
    </Representation>
  </Period>
```

It should be noted that in the “SegmentInfo” of the “Period”, addresses of program segments are described by urls, for example, <url sourceurl=“www.example.com/program1.3gp”> indicates the address of the first program segment, <url sourceurl=“www.example.com/program2.3gp”> indicates the address of the second program segment, and <url sourceurl=“www.example.com/program3.3gp> indicates the address of the third program segment, assuming that the duration of each segment is 10 s. Media content presetting information is described by “AdInfo”, for example, http://www.example.com/Adselect/33 is used to indicate media content obtaining information, where http://www.example.com/Adselect indicates a media content obtaining address, and 33 indicates an identifier of an insertion position of the media content. It is assumed that the media content obtaining address may be specifically mapped to a dynamic processing file of the media content on the server.

The process of detecting and processing the “Period” by the client terminal is as follows: when the “AdInfo” in the “Period” is detected by the client terminal, the client terminal can know that the “Period” includes media content presetting information. Afterwards, the client sends segment requests one by one to the server according to the sequence of segment addresses in the “SegmentInfo”, where “SegmentInfo” is in the “Representation”, and “Representation” is under the “Period”. First the client terminal requests program content segments from the server according to the sequence of the program segment addresses, and the server returns the program segment contents. When the insertion time indicated by “Ad-starttime” arrives, the client terminal sends a first media content request message to the server, where the first media content request message carries the user information. The user information may be a user identifier, or may be complete user description information, for example, name, sex, hobby, and location of the user.

In addition, if the server records user description information, the first media content request message only needs to carry a user identifier. In this case, the first media content request message sent according to the media content obtaining information may be expressed as follows:
GET /Adselect/33%userId%
Host: www.example.com

The above media content obtaining information is composed of a media content obtaining address and an identifier of the insertion position of the media content; “www.example.com/Adselect” in the message body indicates the media content obtaining address; “33” in the message body indicates the identifier of the insertion position of the media content; and “userId” in the message body indicates a user identifier.

403. The server screens out a target media content from locally stored media contents according to the user information.

Specifically, the server obtains insertion position information of the media content according to the identifier of the insertion position of the media content in the media content obtaining information, where the insertion position information of the media content includes a duration of the insertion position of the media content and a program associated with the insertion position of the media content. For example, the dynamic processing file of the media content on the server obtains the insertion position information of the media content according to the identifier “33” of the insertion position of the media content.

Afterwards, the server screens out the target media content from the locally stored media contents according to the user information and the insertion position information of the media content. The target media content matches the user information.

404. The server sends a first media content response message to the client terminal, where the first media content response message includes addresses of all segments of the target media content.

For example, the format of the first media content response message may be expressed as follows:

```
HTTP/1.1 200 OK
Content-Type: text/xml;
Content-length: length
<?xml version=“1.0” encoding=“utf-8”?>
<SegmentInfo duration=“PT10S” baseURL=“rep2/”>
    <InitialisationSegmentURL sourceURL=“seg-init.3gp”/>
    <Url sourceURL=“adseg-1.3gp”/>
    <Url sourceURL=“adseg-2.3gp”/>
    <Url sourceURL=“adseg-3.3gp”/>
  </SegmentInfo>
```

Where <Url sourceURL=“adseg-1.3gp”/>, <Url sourceURL=“adseg-2.3gp”/>, and <Url sourceURL=“adseg-3.3gp”/> indicate addresses of all segments of the target media content. The description structure of the addresses of the segments may be defined in accordance with the structures of the “SegmentInfo” and its subelements in the prior MPD file.

405. The client terminal sends subsequent segment request messages in sequence according to the addresses of the segments after receiving the first media content response message.

It should be noted that if the first media content response message includes the address of an initial segment, the initial segment needs to be requested first. Otherwise, requests are sent one by one directly according to the addresses of segments. The specific request process is the same as the existing program segment request process, and is not further described herein.

406. The server sends segment contents corresponding to the addresses of the segments carried in the subsequent segment requests.

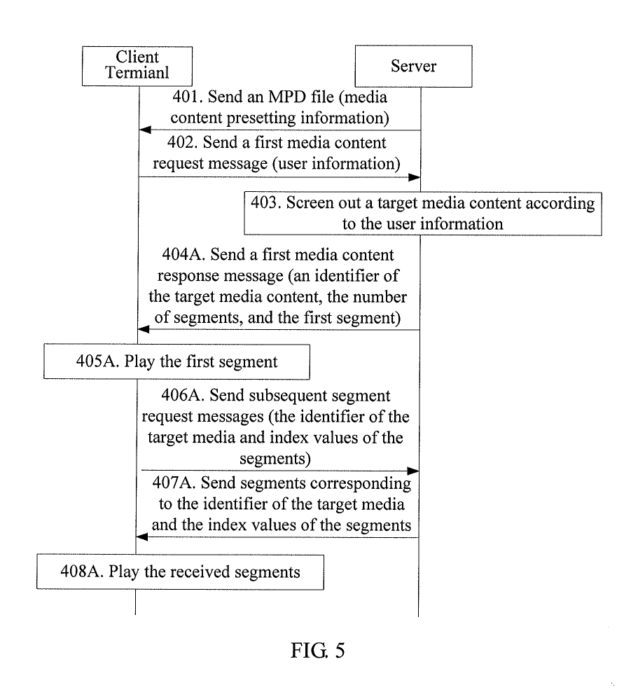

Further, as shown in FIG. 5, the above steps 404-406 may also be replaced with the following steps 404A-408A for implementation:

404A. The server sends a first media content response message to the client terminal, where the first media content response message includes an identifier, the number of segments, and a first segment content of the target media content.

For example, the format of the first media content response message may be expressed as follows:

HTTP/1.1 200 OK
Content-Type: multipart/mixed; boundary=“abracadabra”
Content-length: 1080
--abracadabra
Content-Type: video/3gpp
...moof...mfhd.... tfra......trun.......
--abracadabra
Content-Type: text/plain
segmentNumber=4& Contentindex=9
--abracadabra

Where “ . . . moof . . . mfhd . . . tfra . . . trun” indicates the first segment content, “segmentNumber” indicates the number of segments, and “contentIndex” indicates a media content index.

405A. The client terminal plays the first segment content of the target media content after receiving the first media content response message.

406A. According to the media content obtaining information, send subsequent segment request messages carrying the identifier of the target media and index values of the segments.

For example, the structure of the subsequent segment request messages may be expressed as follows:
GET /Adselect/33%Contentindex%/%index%
Host: www.example.com

The media content obtaining information is composed of a media content obtaining address and an identifier of the insertion position of the media content; “www.example.com/Adselect” in the message body indicates the media content obtaining address; “33” in the message body indicates the identifier of the insertion position of the media content; “Contentindex” in the message body indicates the identifier of the target media and comes from the first media content response message in step 404A; and “index” in the message body indicates the segment index, where the segment index is not greater than the number of segments.

407A. The server sends segment contents corresponding to the identifier of the target media and the index values of the segments to the client terminal.

For example, specifically the following response message format may be used to return segment contents corresponding to the identifier of the target media and the index values of the segments:

HTTP/1.1 200 OK
Content-Type: video/3gpp
Content-length: 1080
...moof...mfhd.... tfra......trun......

Where “ . . . moof . . . mfhd . . . tfra . . . trun . . . ” indicates segment contents corresponding to the identifier of the target media and the index values of the segments.

408A. The client terminal plays the received segment contents.

Afterwards, the above steps of 406A-408A are repeated until the client terminal obtains all segments of the target media content.

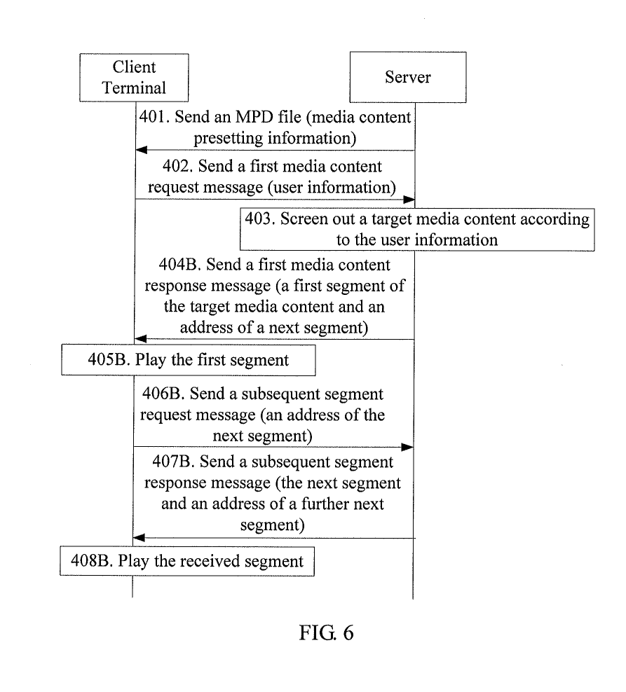

Further, as shown in FIG. 6, the above steps 404-406 may also be replaced with the following steps 404B-408B for implementation:

404B. Send a first media content response message to the client terminal, where the first media content response message includes a first segment content and an address of a next segment of the target media content.

For example, the format of the first media content response message may be expressed as follows:

HTTP/1.1 200 OK
Content-Type: video/3gpp
Content-length: 1080
...moo...mfhd.... tfra......trun....... urld
http:// www.adserver.com/file/adseg-2.3gp

In the example, a box is extended to implement encapsulation of the address of the next segment of the media content, where urld is an extended box, and the extended box is placed in the moof and describes the address of the next segment by using a field, and “http://www.adserver.com/file/adseg-2.3gp” indicates the address of the next segment of the media content.

405B. The client terminal plays the first segment content of the target media content after receiving the first media content response message.

406B. The client terminal sends a subsequent segment request message according to the address of the next segment.

For example, the structure of the subsequent segment request message may be expressed as follows:
GET file/adseg-2.3gp
Host: www.adserver.com

407B. The server sends a next segment response message, where the next segment response message carries a next segment content and an address of a further next segment. The format of the next segment response message is the same as that of the first response message in the above step 405B.

408B. The client terminal plays the received segment content. Afterwards, the above steps 406B-408B are repeated until the client terminal obtains all segments of the target media content.

Further, the “Period” carrying media content presetting information in the MPD file received by the client terminal in the above step 402, addresses of program segments are described by “Url”. In the actual application, the above addresses of the program segments may also be described by “UrlTemplate”. In this case, the value of “Ad-InsertIndex” needs to be defined when media content presetting information is described by “AdInfo”. The description about the “Period” carrying media content presetting information is expressed as follows:

```
<Period start“PT30S”>
    <Representation
      mimeType=“video/3gpp; codecs=mp4v.20.9, mp4a.E1”
      bandwidth=“256000”>
<SegmentInfo>
<UrlTemplate sourceUrl=“http://www.example.com/program/
$Index$.3gp”/>
<AdInfo ad-sourceURL=http://www.example.com/Adselect/33
ad-InsertIndex=3/>
</SegmentInfo>
    </Representation>
  </Period>
```

Where addresses of program segments in the “SegmentInfo” are described by “UrlTemplate”, and media content obtaining information is described by “ad-sourceURL”, where “ad-sourceURL” is defined as http://www.example.com/Adselect/33. “ad-InsertIndex” defines the insertion index of the media content segments in the program segments. For previous example, “ad-InsertIndex=3”, the client terminal needs to first request the program content segments of “index=1” and “index=2”, and then request the media content when “ad-InsertIndex=3”.

It should be noted that when addresses of the program segments are described by UrlTemplate, sending of the first media content request message and the subsequent processing are the same as the sending and subsequent processing in the case that the program segment addresses are described by Url in step 402, and are not further described herein. After the client terminal receives all segment contents of the target media, begin with index value 3, the client terminal requests program segment contents again according to the index values of the program segments.

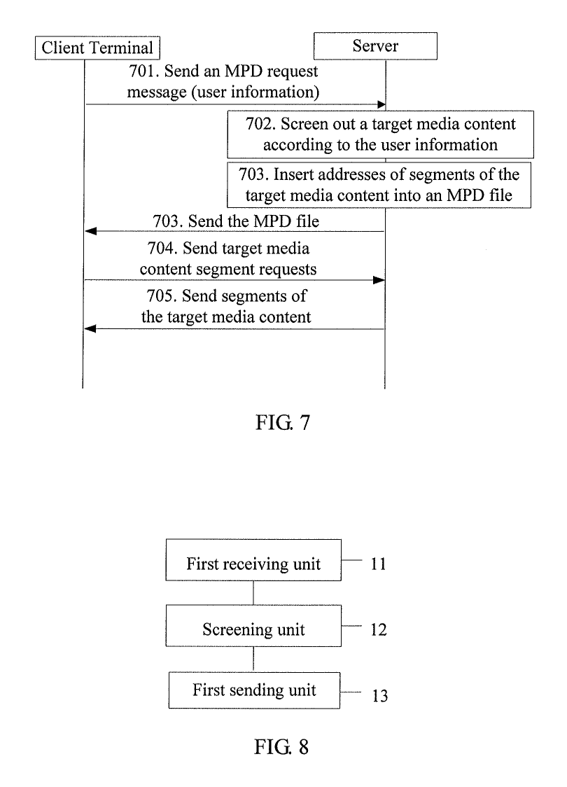

The above method for dynamic media content insertion based on HTTP streaming is implemented by using mode 1. The process of implementing customized media content insertion by using mode 2 is described hereunder. As shown in FIG. 7, the method includes:

701. A client terminal sends user information to the server through an MPD request message.

702. The server receives the MPD request message, and screens out target media content according to the user information.

703. The server divides the target media content, inserts addresses of segments of the target media content and addresses of program segments into an MPD file, and sends the MPD file that carries inserted addresses of segments of the target media content to the client terminal.

704. The client terminal receives the MPD file, and sends target media content segment requests one by one according to the sequence of addresses of segments of the target media content in the MPD file.

705. The server sends the corresponding segments of the target media content to the client terminal when receiving the target media content segment requests.

It should be noted that the MPD file mentioned in step 303 may also carries inserted addresses of program segments, and the client terminal sends segment requests one by one according to the sequence of addresses of segments of the target media content and addresses of program segments in the MPD file. If the client terminal receives a program segment, the client terminal plays the content of the program segment; or if a segment of the target media content is received, the client terminal plays the content of the media content segment, so that customized media contents can be dynamically inserted in the process of playing program streams. Meanwhile, because segments of the target media content inserted into the MPD file received by the user in the above embodiment are obtained by screening according to the user information, different users receive different segments, thus implementing customized media content insertion.

Correspondingly, an embodiment of the present invention further provides an apparatus for dynamic media content insertion based on HTTP streaming, where the apparatus may be specifically a server. As shown in FIG. 8, the apparatus includes a first receiving unit 11, a screening unit 12, and a first sending unit 13.

The first receiving unit 11 is configured to receive a request message that is sent by a client terminal and carries user information; the screening unit 12 is configured to screen out a target media content from locally stored media contents according to the user information; and the first sending unit 13 is configured to send the target media content to the client terminal.

The target media content includes: an advertisement or a trailer of a program, one of subplots of a program, or any combination thereof.

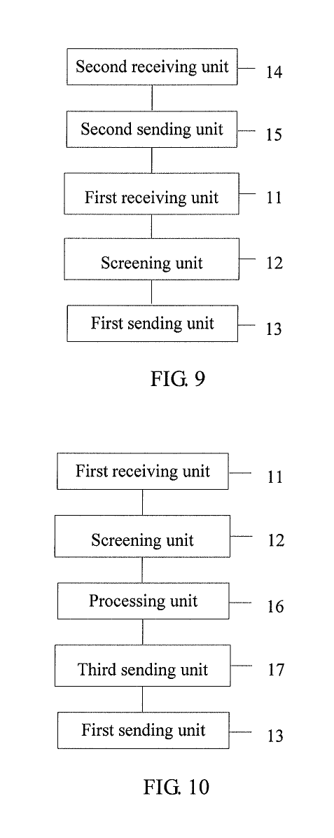

Further, as shown in FIG. 9, when the apparatus implements dynamic customized media content insertion by using mode 1, the apparatus includes a second receiving unit 14 and a second sending unit 15.

Before the first receiving unit 11 receives a request message that is sent by the client terminal and carries user information, the second receiving unit 14 is configured to receive an MPD request message sent by the client terminal; and the second sending unit 15 is configured to send an MPD file that carries inserted media content presetting information to the client terminal.

It should be noted that the media content presetting information may be located in the MPD file, specifically in “Period”, or located in “Representation” under the “Period”, or located in “SegmentInfo”, where “SegmentInfo” is under the “Representation”, and “Representation” is under the “Period”.

The media content presetting information includes: media content obtaining information and an insertion position of a first media content segment; the insertion position of the first media content segment may be insertion time or an insertion index relative to a program segment. The media content obtaining information includes an identifier of the insertion position of the media content.

The MPD file may refer to the above Table 1.

When mode 1 is used, the first receiving unit 11 is specifically configured to receive a first media content request message that carries user information, first media content request message is sent by the client terminal, and the client terminal is according to the media content obtaining information and.

In this case, when mode 1 is used, the screening unit 12 includes: an obtaining module and a screening module (not illustrated in FIG. 9).

The obtaining module is configured to obtain insertion position information of the media content according to the identifier of the insertion position of the media content in the media content obtaining information, where the insertion position information of the media content includes a duration of the insertion position of the media content and a program associated with the insertion position of the media content.

The screening module is configured to screen out the target media content from the locally stored media contents according to the user information and the insertion position information of the media content.

When mode 1 is used, the first sending unit 13 includes at least one of the following modules: a first sending module, a second sending module, and a third sending module.

The first sending module is configured to: send a first media content response message to the client terminal, where the first media content response message includes addresses of all segments of the target media content; and after subsequent segment request messages sent by the client terminal according to the addresses of the segments are received, send segment contents corresponding to the addresses of the segments to the client terminal.

The second sending module is configured to: send a first media content response message to the client terminal, where the first media content response message includes an identifier, the number of segments, and a first segment of the target media content; and after subsequent segment request messages that are sent by the client terminal according to the media content obtaining information and carry the identifier of the target media and index values of the segments are received, send segment contents corresponding to the identifier of the target media and the index values of the segments to the client terminal.

The third sending module is configured to: send a first media content response message to the client terminal, where the first media content response message includes a first segment and an address of a next segment of the target media content; and after a subsequent segment request message sent by the client terminal according to the address of the next segment is received, send a subsequent segment response message, where the subsequent segment response message carries the next segment and an address of a further next segment.

Further, as shown in FIG. 10, when the apparatus implements dynamic customized media content insertion by using mode 2, the apparatus includes a processing unit 16 and a third sending unit 17.

After the first receiving unit 11 receives a MPD request message that is sent by the client terminal and carries user information and the screening unit 12 screens out the target media content, the processing unit 16 is configured to insert addresses of segments of the target media content into an MPD file; and the third sending unit 17 is configured to send the MPD file carrying the inserted addresses of segments of the target media content to the client terminal.

When the first receiving unit 11 receives segment requests sent by the client terminal according to the addresses of segments of the target media content, the first sending unit 13 is specifically configured to send media contents corresponding to the addresses of segments to the client terminal.

It should be noted that the MPD file sent by the third sending unit 17 may also carry inserted addresses of program segments. In this case, if the server receives segment requests sent by the client terminal according to addresses of program segments, the server sends program segments to the client terminal.

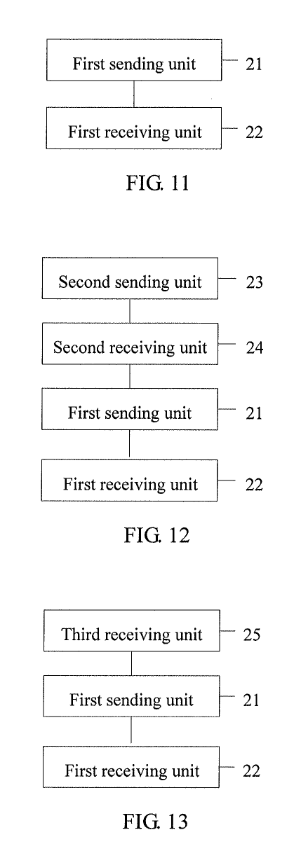

An embodiment shown in FIG. 11 provides an apparatus for dynamic media content insertion based on HTTP streaming, where the apparatus may be specifically a client terminal and includes: a first sending unit 21 and a first receiving unit 22.

The first sending unit 21 is configured to send a request message carrying user information to a server; and the first receiving unit 22 is configured to receive a media content that is sent by the server and matches the user information, and play the media content.

Further, when the apparatus implements dynamic customized media content reception by using mode 1, as shown in FIG. 12, the apparatus further includes a second sending unit 23 and a second receiving unit 24.

Before the first sending unit 21 sends a request message that carries user information to the server, the second sending unit 23 is configured to send an MPD request message to the server; and the second receiving unit 24 is configured to receive an MPD file that is sent by the server and carries inserted media content presetting information.

It should be noted that the media content presetting information may be located in the MPD file, specifically in “Period”, or located in “Representation” under the “Period”, or located in “SegmentInfo”, where “SegmentInfo” id under the “Representation”, and “Representation” is under the “Period”. The media content presetting information includes: media content obtaining information and an insertion position of a first media content segment; the insertion position of the first media content segment may be insertion time or an insertion index relative to a program segment. The media content obtaining information includes an identifier of the insertion position of the media content.

The MPD file may refer to the above Table 1.

In this case, the first sending unit 21 is specifically configured to send, according to the media content obtaining information in the media content presetting information, a first media content request message that carries user information to the server when detecting that the MPD file includes the media content presetting information.

The first receiving unit 22 includes at least one of the following modules (not illustrated in FIG. 12): a first receiving module, a second receiving module, and a third receiving module.

The first receiving module is configured to: receive a first media content response message sent by the server, where the first media content response message includes addresses of all segments of the media content matching the user information; and after subsequent segment request messages are sent to the server according to the addresses of the segments, receive segment contents sent by the server.

The second receiving module is configured to: receive a first media content response message sent by the server, where the first media content response message includes an identifier, the number of segments, and a first segment of the media content matching the user information; and after subsequent segment request messages that carry the identifier of the media content and index values of the segments are sent to the server according to the media content obtaining information, receive segment contents sent by the server.

The third receiving module is configured to: receive a first media content response message sent by the server, where the first media content response message includes a first segment and an address of a next segment of the media content matching the user information; and after a subsequent segment request message is sent to the server according to the address of the next segment, receive a subsequent segment response message sent by the server, where the subsequent segment response message carries the next segment and an address of a further next segment, and repeat segment requests and responses until all segments of the media content are obtained.

Further, when the apparatus implements dynamic customized media content reception by using mode 2, the first sending unit 21 is specifically configured to send an MPD request message carrying user information to the server; in this case, as shown in FIG. 13, the apparatus further includes a third receiving unit 25, configured to receive an MPD file that is sent by the server and carries inserted addresses of segments of the media content matching the user information; and the first sending unit 21 is further configured to send media content segment requests according to the addresses of the segments of the media content matching the user information, the first receiving unit 22 is specifically configured to receive media contents sent by the server.

It should be noted that because the MPD file received by the third receiving unit 25 may also carry inserted addresses of program segments, the client terminal sends segment requests one by one according to the sequence of addresses of segments of the target media content and addresses of program segments in the MPD file. If the client terminal receives a program segment, the client terminal plays the content of the program segment; or if a segment of the target media content is received, the client terminal plays the content of the segment of the media content.

With the apparatus for dynamic media content insertion based on HTTP streaming according to the above embodiments of the present invention, because segments of the media content received by the client terminal are obtained by screening by the server according to the user information, while the user information of different client terminals has differences in customization, different users can receive media content segments meeting respective requirements. Compared with the prior art in which all client terminals demanding a same program watch the same dynamic media content when the clients watch the program through HTTP streaming, embodiments of the present invention can enable all the client terminal demanding the same program to watch customized dynamic media contents meeting respective characteristics, thus solving the problem that customized insertion fails to be implemented when media contents are transmitted through HTTP streaming, so that customized insertion of dynamic media contents is implemented.

An embodiment of the present invention further provides a system for dynamic media content insertion based on HTTP streaming, including: the apparatus for dynamic media content insertion based on HTTP streaming shown in any one of FIGS. 8-10 and another apparatus for dynamic media content insertion based on HTTP streaming shown in any one of FIGS. 11-13.

The apparatus for dynamic media content insertion based on HTTP streaming according to any one of FIGS. 8-10 is specifically a server, configured to: receive a request message that is sent by a client terminal and carries user information; screen out a target media content from locally stored media contents according to the user information; and send the target media content to the client terminal so that the client terminal can play the target media content.

Another apparatus for dynamic media content insertion based on HTTP streaming shown in any one of FIGS. 11-13 is specifically a client terminal, configured to: send a request message that carries user information to a server; and receive a media content that is sent by the server and matches the user information, and play the media content.

In the system for dynamic media content insertion based on HTTP streaming, because the media content received by the client terminal is obtained by screening by the server according to the user information, while the user information of different client terminals has differences in customization, different users can receive media contents meeting respective requirements. Compared with the prior art in which all client terminals demanding a same program watch the same dynamic media content when the client terminals watch the program through HTTP streaming, embodiments of the present invention can enable all the client terminals demanding the same program to watch customized dynamic media contents meeting respective characteristics, thus solving the problem that customized insertion fails to be implemented when media contents are transmitted through HTTP streaming, so that customized insertion of dynamic media contents is implemented.

Embodiments of the present invention are mainly applied to the process of dynamic media content insertion. When the client terminal watches a program through HTTP streaming, the customized insertion of the media content can be implemented.

Through the description of the foregoing embodiments, persons skilled in the art may clearly understand that the present invention may be implemented by software in addition to necessary general hardware, or by hardware only, but the former is preferred in most circumstances. Based on such understanding, the technical solutions of the present invention in essence or the portions contributing to the prior art can be embodied in the form of a software product. The computer software product is stored in a readable storage medium, such as a computer floppy disk, a hard disk, or a Compact Disc Read-Only Memory (CD-ROM), including several instructions to cause a computer device (which may be a personal computer, a server, or a network device) to execute the method described in each embodiment of the present invention.

The foregoing descriptions are merely exemplary embodiments of the present invention, but not intended to limit the present invention. Any variation or replacement made by persons skilled in the art without departing from the spirit of the present invention should fall within the protection scope of the present invention. Therefore, the protection scope of the present invention is subject to the protection scope of the claims.

What is claimed is:

1. A method for dynamic media content insertion based on Hypertext Transfer Protocol HTTP streaming, wherein dynamic media contents are transmitted through HTTP streaming, and the method comprises:
receiving a request message that is sent by a client terminal and carries user information;
screening out a target media content from locally stored media contents according to the user information; and
sending the target media content to the client terminal so that the client terminal can play the target media content.

2. The method for dynamic media content insertion based on HTTP streaming according to claim 1, wherein before receiving a request message that is sent by the client terminal and carries user information, the method further comprises: receiving a media presentation description MPD request message from the client terminal, and sending an MPD file that carries inserted media content presetting information to the client terminal.

3. The method for dynamic media content insertion based on HTTP streaming according to claim 2, wherein the media content presetting information is located in a period “Period”, or located in description information “Representation” under the “Period”, or located in segment information (SegmentInfo), where “SegmentInfo” is under the “Representation”, and “Representation” is under the “Period”.

4. The method for dynamic media content insertion based on HTTP streaming according to claim 2, wherein the media content presetting information comprises: media content obtaining information and an insertion position of a first media content segment, wherein the insertion position of the first media content segment can be insertion time or an insertion index relative to a program segment.

5. The method for dynamic media content insertion based on HTTP streaming according to claim 4, wherein the media content obtaining information comprises an identifier of the insertion position of the media content.

6. The method for dynamic media content insertion based on HTTP streaming according to claim 4, wherein the receiving a request message that is sent by the client terminal and carries user information comprises:
receiving a first media content request message that is sent by the client terminal according to the media content obtaining information and carries user information.

7. The method for dynamic media content insertion based on HTTP streaming according to claim 5, wherein the screening out a target media content from locally stored media contents according to the user information comprises:
obtaining insertion position information of the media content according to the identifier of the insertion position of the media content in the media content obtaining information, wherein the insertion position information of the media content comprises a duration of the insertion position of the media content and a program associated with the insertion position of the media content; and
screening out the target media content from the locally stored media contents according to the user information and the insertion position information of the media content.

8. The method for dynamic media content insertion based on HTTP streaming according to claim 4, wherein the sending the target media content to the client terminal comprises:
sending a first media content response message to the client terminal, wherein the first media content response message comprises addresses of all segments of the target media content; and after receiving subsequent media content segment request messages sent by the client terminal one by one according to the addresses of the segments, sending segment contents corresponding to the addresses of the segments to the client terminal; or
sending a first media content response message to the client terminal, wherein the first media content response message comprises an identifier, the number of segments, and a content of a first segment of the target media content; and after receiving subsequent segment request messages that are sent by the client terminal according to the media content obtaining information and carry the identifier of the target media and index values of the segments, sending segment contents corresponding to the identifier of the target media and the index values of the segments to the client terminal; or
sending a first media content response message to the client terminal, wherein the first media content response message comprises a first segment content and an address of a next segment of the target media content; and after receiving a segment request message sent by the client terminal according to the address of the next segment, sending a next segment response message, wherein the next segment response message carries a next segment content and an address of a further next segment, and repeating segment requests and responses until all segments of the media content are obtained.

9. The method for dynamic media content insertion based on HTTP streaming according to claim 1, wherein: the receiving a request message that is sent by the client terminal and carries user information comprises: receiving an MPD request message that is sent by the client terminal and carries user information;
after screening out the target media content from the locally stored media contents according to the user information, the method further comprises: inserting addresses of segments of the target media content into an MPD file; and sending the MPD file that carries the inserted addresses of the segments of the target media content to the client terminal; and
the sending the target media content to the client terminal comprises: when receiving segment requests sent by the client terminal according to the addresses of the segments of the target media content, sending media contents corresponding to the addresses of the segments to the client terminal.

10. An apparatus for dynamic media content insertion based on HTTP streaming, wherein dynamic media contents are transmitted through HTTP streaming, and the apparatus comprises:
a first receiving unit, configured to receive a request message that is sent by a client terminal and carries user information;
a screening unit, configured to screen out a target media content from locally stored media contents according to the user information; and
a first sending unit, configured to send the target media content to the client terminal so that the client terminal can play the target media content.

11. The apparatus for dynamic media content insertion based on HTTP streaming according to claim 10, further comprising a second receiving unit and a second sending unit, wherein:
the second receiving unit is configured to receive an MPD request message sent by the client terminal before the first receiving unit receives a request message that is sent by the client terminal and carries user information; and the second sending unit is configured to send an MPD file that carries inserted media content presetting information to the client terminal.

12. The apparatus for dynamic media content insertion based on HTTP streaming according to claim 11, wherein the media content presetting information comprises: media content obtaining information and an insertion position of a first media content segment, wherein the insertion position of the first media content segment can be insertion time or an insertion index relative to a program segment.

13. The apparatus for dynamic media content insertion based on HTTP streaming according to claim 12, wherein the media content obtaining information comprises an identifier of the insertion position of the media content.

14. The apparatus for dynamic media content insertion based on HTTP streaming according to claim 12, wherein the first receiving unit is specifically configured to receive a first media content request message that is sent by the client terminal according to the media content obtaining information and carries user information.

15. The apparatus for dynamic media content insertion based on HTTP streaming according to claim 13, wherein the screening unit comprises:
an obtaining module, configured to obtain insertion position information of the media content according to the identifier of the insertion position of the media content in the media content obtaining information, wherein the insertion position information of the media content comprises a duration of the insertion position of the media content and a program associated with the insertion position of the media content; and
a screening module, configured to screen out the target media content from the locally stored media contents according to the user information and the insertion position information of the media content.

16. The apparatus for dynamic media content insertion based on HTTP streaming according to claim 12, wherein the first sending unit comprises at least one of the following modules:
a first sending module, configured to: send a first media content response message to the client terminal, wherein the first media content response message comprises addresses of all segments of the target media content; and after subsequent segment request messages sent by the client terminal according to the addresses of the segments are received, send segment contents corresponding to the addresses of the segments to the client terminal;
a second sending module, configured to: send a first media content response message to the client terminal, wherein the first media content response message comprises an identifier, the number of segments, and a first segment of the target media content; and after subsequent segment request messages that are sent by the client terminal according to the media content obtaining information and carry the identifier of the target media and index values of the segments are received, send segment contents corresponding to the identifier of the target media and the index values of the segments to the client terminal; and
a third sending module, configured to: send a first media content response message to the client terminal, wherein the first media content response message comprises a first segment and an address of a next segment of the target media content; and after a subsequent segment request message sent by the client terminal according to the address of the next segment is received, send a subsequent segment response message, wherein the subsequent segment response message carries the next segment and an address of a further next segment.

17. The apparatus for dynamic media content insertion based on HTTP streaming according to claim 10, wherein: the first receiving unit is specifically configured to receive an MPD request message that is sent by the client terminal and carries user information;
the apparatus further comprises a processing unit and a third sending unit, wherein the processing unit is configured to insert addresses of segments of the target media content into an MPD file, and the third sending unit is configured to send the MPD file that carries the inserted addresses of the segments of the target media content to the client terminal;
when the first receiving unit receives segment requests sent by the client terminal according to the addresses of the segments of the target media content, the first sending unit is specifically configured to send media contents corresponding to the addresses of the segments to the client terminal.
